(19) United States
(12) Patent Application Publication
(10) Pub. No.: US 2010/0312157 A1
(43) Pub. Date: Dec. 9, 2010

(54) ROTARY MASSAGE DEVICE

(76) Inventor: Yongxing Yan, London (GB)

Correspondence Address: MCCARTER & ENGLISH, LLP BOSTON, 265 Franklin Street, Boston, MA, 02110, US

(21) Appl. No.: 12/792,412

(22) Filed: Jun. 2, 2010

(30) Foreign Application Priority Data
Jun. 3, 2009 (EP) EP 09161813.2

(51) Int. Cl. A61H 15/00

(52) U.S. Cl. 601/112

(57) ABSTRACT

A massage apparatus comprising a drive unit and a rotatable head coupled to the drive unit for rotation about an axis, and a rotatable head for use with such a massage device. The rotatable head has a skin-engaging end face to contact skin to be massaged. The massage apparatus is configured such that the skin-engaging end face lies in a plane substantially perpendicular to the axis of rotation of the rotatable head. A method of using such a massage device.

### RELATED APPLICATION

This application claims priority to EP 09161813.2, filed Jun. 3, 2009. The entire content of this application is explicitly incorporated herein by reference.

### BACKGROUND

The present invention relates to a massage device and, more particularly, to a mechanical massage device having a rotatable head.

Various devices are known for use in skin massage, and utilise various techniques such as rolling, kneading, suction, pressure, and so on. Such known devices include manually operated devices as well as mechanically automated devices. One such known automated massage device is disclosed in US 2003/0073937 and discloses a device having a pair of parallel rollers mounted in a housing, the housing including a suction port to enable the device to be connected to a vacuum supply to provide massage action through kneading by the rollers rolling across the skin and by suction from the vacuum supply.

Other known massage devices having rotatable heads are disclosed in DE 10-2007-007610 and U.S. Pat. No. 3,906,940.

### SUMMARY

It is an object of the present invention to provide an improved massage device with improved operating movement.

Accordingly, the present invention provides a massage device comprising a drive unit and a rotatable head coupled to the drive unit for rotation about an axis, the rotatable head having a skin-engaging end face to contact skin to be massaged and a cavity in the skin-engaging end face extending into the rotatable head which is sealed closed when the rotatable head is pressed against the skin to be massaged, and which is connectable to a source of vacuum to allow air to be evacuated from the cavity, wherein the skin-engaging end face lies in a plane substantially perpendicular to the axis of rotation of the rotatable head, characterized in that the rotatable head is rotatable about its central axis and the inner walls of the cavity comprise an undulating surface such that, in use, skin drawn into the cavity is pushed by the undulations as the rotatable head rotates.

The drive unit is preferably configured to oscillate the rotatable head back and forth about its axis of rotation.

Preferably, the rotatable head includes a second end face opposite to the skin-engaging end face and, the rotatable head is coupled to the drive unit at the second end face.

The rotatable head preferably includes a fluid passage extending therethrough and in communication with the cavity to allow air to be evacuated from the cavity when closed by skin being massaged.

The fluid passage preferably includes a suction pipe mounted to the rotatable head in fluid communication with the cavity, for connection to a vacuum source to evacuate air from the cavity. In use, the evacuation of air from the cavity causes the skin to be drawn up into the cavity. Preferably, the suction pipe is mounted for rotation with the rotatable head relative to the drive unit.

The inner walls of the cavity comprise an undulating surface such that, in use, skin drawn into the cavity is pushed by the undulations as the rotatable head rotates. This pushing of the skin folds creates the enhanced massage effect.

The cavity in the rotatable head is preferably substantially circular with at least one element projecting from the inside circular wall of the cavity providing said undulating surface.

Preferably, the at least one element comprises a post received in an aperture in the rotatable head.

Preferably, the at least one post has a longitudinal axis substantially parallel with the axis of rotation of the rotatable head. The at least one post is preferably substantially cylindrical.

Preferably, the at least one post is metallic. The at least one post may also be connected to a source of Radio Frequency or low impulse current to enable the same to be transmitted to the skin being massaged.

Preferably, the fluid passage extends though the at least one post and the at least one post includes a suction hole open to the cavity and in fluid communication with the fluid passage.

Preferably, the rotatable head may include at least one LED or a laser emitting means operable to transmit light and heat to the skin to be massaged.

Preferably, the rotatable head comprises a transparent portion between the at least one LED/laser emitting means and the skin-engaging end face to allow light to be transmitted from the at least one LED/laser emitting means to the skin to be massaged. Preferably the transparent portion is made from plexi-glass.

The massage device may include an outer housing enclosing the drive unit. The outer housing may include at least one handle to facilitate manipulation of the massage device.

The massage device may further include at least one actuator to control operation of the massage device. The at least one actuator may be provided on the outer housing or on the at least one handle of the outer housing.

The drive unit may be pneumatically powered. The massage device may further comprise a source of compressed gas/air to power the drive unit. The massage device may further comprise a control circuit to control operation of the massage device and drive unit thereof. The massage device may also include an electric valve controlled by the control circuit to regulate the supply of compressed air/gas to the drive unit.

Alternatively, the drive unit may be electrically powered, and/or driven by an electric motor.

The massage device may include a suction device connected to the fluid passage to evacuate air from the cavity in the rotatable head.

Preferably, the massage device is configured such that the rotational speed of the rotatable head can be controlled within a range of different speeds.

### BRIEF DESCRIPTION OF THE DRAWINGS

A preferred embodiment of the present invention will now be described, by way of example only, with reference to the accompanying drawings, in which:

FIG. 1 shows a perspective view of a massage apparatus of the present invention;

FIG. 2 shows another perspective view of the apparatus of FIG. 1 but with a cross-section of the outer housing removed to show the drive unit within the outer housing;

FIG. 3 shows another perspective view of the apparatus of FIGS. 1 and 2 with the outer housing completely removed;

FIG. 4 shows an exploded top perspective view of the apparatus shown in FIG. 3;

FIG. 5 shows an exploded bottom perspective view of the apparatus shown in FIGS. 3 and 4;

FIG. 6 shows a top perspective view of the drive unit of the apparatus of the invention;

FIG. 7 shows a partially exploded top perspective view of the drive unit shown in FIG. 6;

FIG. 8 shows an exploded top perspective view of the drive unit shown in FIGS. 6 and 7;

FIG. 9 shows a top perspective view of the drive unit of FIGS. 6 to 8 with the support plate secured thereto;

FIG. 10 shows a bottom perspective view of the drive unit and support plate of FIG. 9;

FIG. 11 shows an exploded top perspective view of the drive unit and support plate of FIGS. 9 and 10; and

FIG. 12 shows an exploded bottom perspective view of the drive unit and support plate of FIGS. 9 to 11

FIG. 13 shows a top perspective view of the rotatable head of the apparatus of the invention;

FIG. 14 shows a bottom perspective view of the rotatable head of FIG. 13;

FIG. 15 shows an exploded top perspective view of the rotatable head of FIGS. 13 and 14;

FIG. 16 shows an exploded bottom perspective view of the rotatable head of FIGS. 13 to 15; and

FIG. 17 shows a schematic cross-sectional view of the rotatable massage device head of the invention during use on the skin of a user.

### DETAILED DESCRIPTION

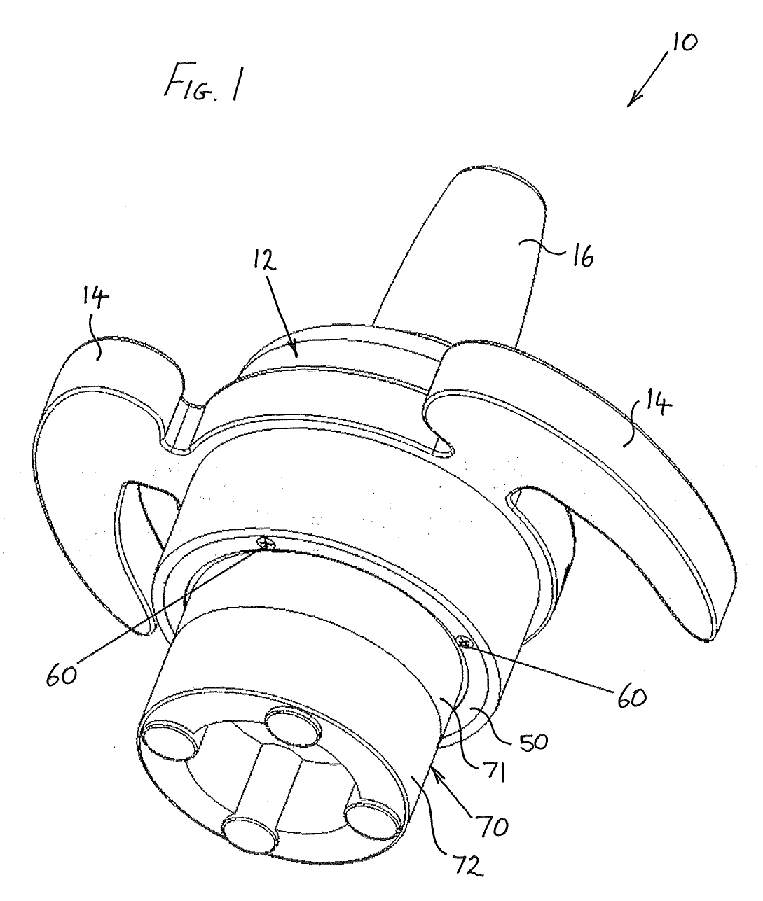

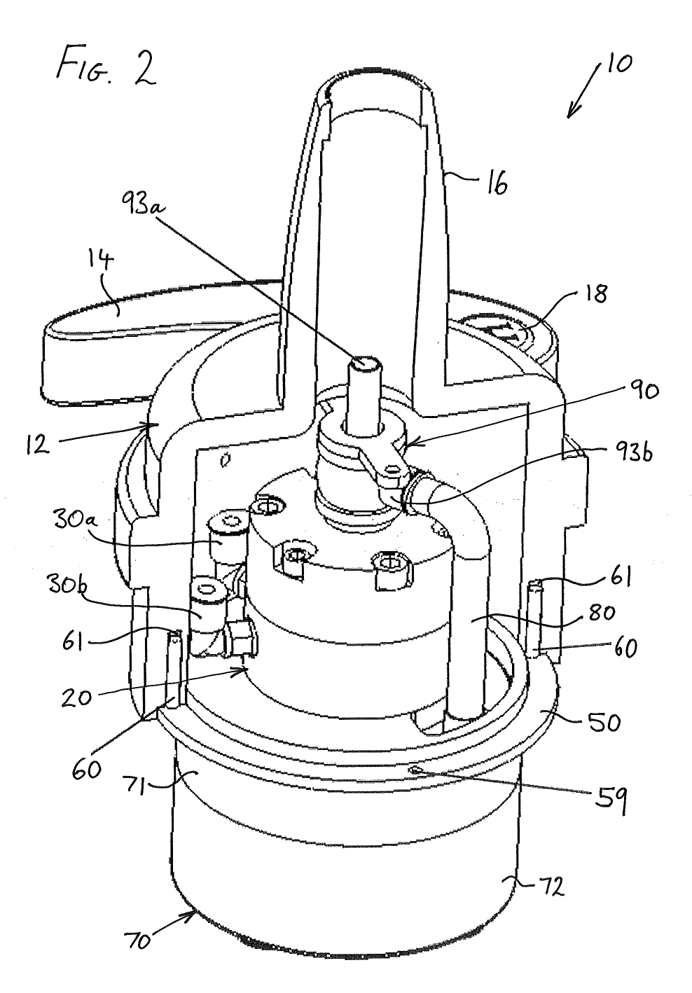

Referring now to FIGS. 1 and 2, an automated massage device 10 according to the present invention is shown, and generally comprises an outer housing 12, a drive unit 20, a support plate 50 and a rotatable head 70. The outer housing 12 includes a pair of handles 14 to allow an operator to control the massage device 10. The support plate 50 is fixed to the drive unit 20, and the outer housing 12 is secured to the support plate 50, as described in more detail below. The rotatable head 70 is moveable relative to the drive unit 20, support plate 50 and outer housing 12.

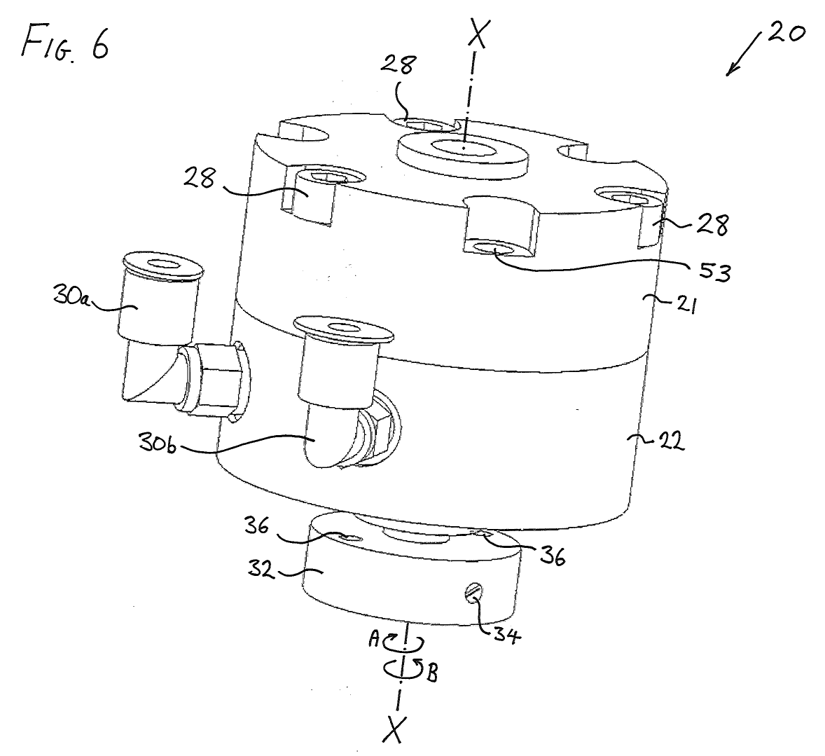

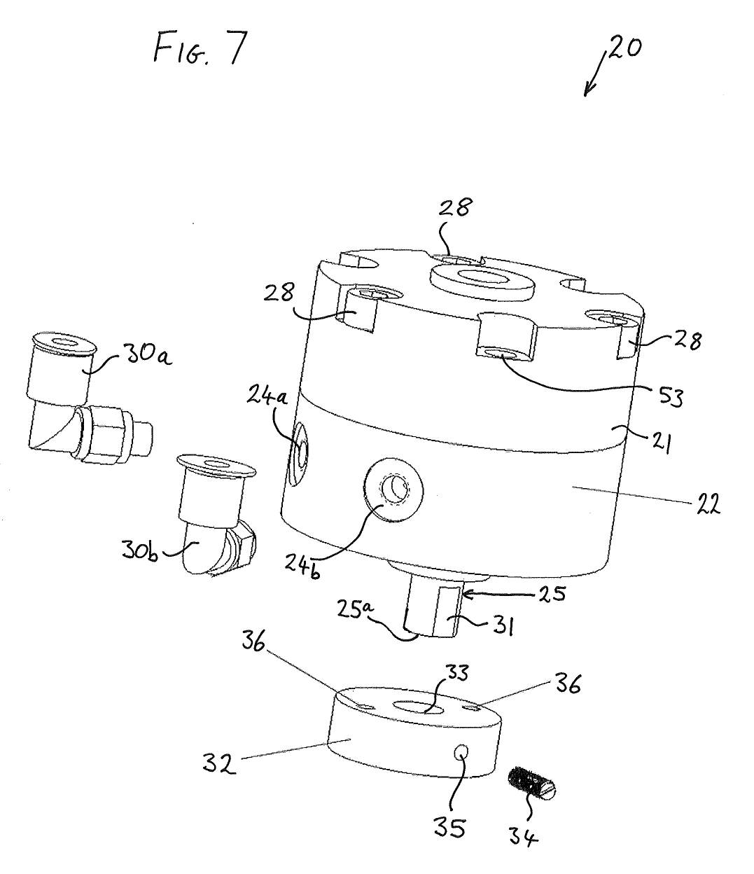

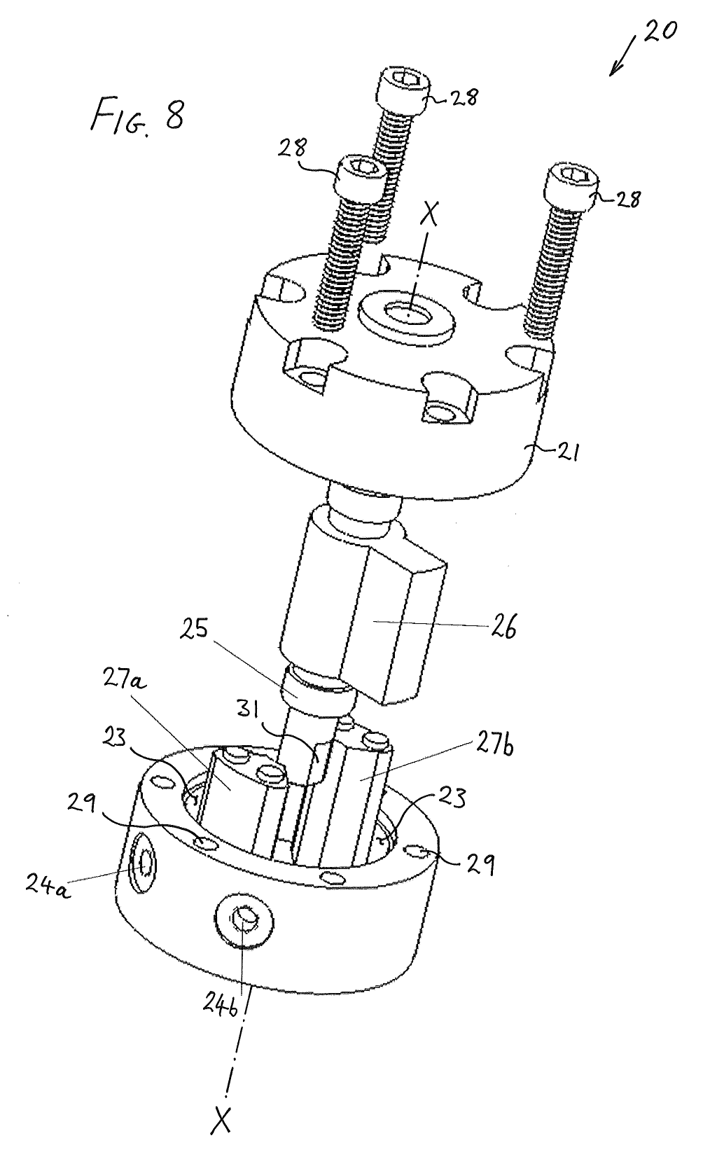

The drive unit 20 is shown in more detail in FIGS. 6 to 8, and comprises an upper casing 21 and a lower casing 22 which are secured together to define the generally cylindrical outer body of the drive unit 20 and to enclose an inner chamber 23 of the drive unit 20 (see FIG. 8). The lower casing 22 includes first and second ports 24a, 24b extending through the wall of the lower casing 22 into the inner chamber 23. A drive shaft 25 is rotatably mounted within the inner chamber 23 with its central axis aligned along the central axis X-X of the drive unit 20, and has top end (not shown) received in a fitting (not shown) in the upper casing 21, and a bottom end 25a which extends through an aperture (not shown) in the middle of the end wall of the lower casing 22. Thereby, the drive shaft 25 is freely rotatable within the inner and outer casings 21, 22, with its bottom end 25a protruding out of the lower casing 22.

The drive shaft 25 has a piston 26 in the form of a square plate extending radially from one side of the drive shaft 25. The lower casing 22 includes a pair of stops 27a, 27b within the inner chamber 23 such that the range of rotation of the drive shaft 25 is limited by the piston 26 abutting the respective stop 27a/27b. The position of the stops 27a, 27b thereby define the maximum range of rotation of the drive shaft 25. In the embodiment shown, the drive shaft 25 is able to rotate over about 90 degrees, although the stops 27a, 27b could be arranged within the inner chamber 23 such that the range of motion may be 180 degrees, 270 degrees, or many other angles as desired.

The upper casing 21 is secured to the lower casing 22 by three bolts 28 (see FIG. 8), which are spaced equidistantly around the top of the upper casing 21 and extend from the top of the upper casing 21, through the side wall thereof, and are received in correspondingly positioned threaded holes 29 in the upper edge of the side wall of the lower casing 22. Once the bolts 28 are tightened into the threaded holes 29, the join between the upper and lower casings 21, 22 is sealed airtight, with the only fluid path into the inner chamber 23 being through the two ports 24a, 24b (the drive shaft 25 is mounted within the inner chamber 23 such that air cannot escape around the drive shaft 25 where it exits the lower casing 22).

Each of the two ports 24a, 24b includes a right-angled connection pipe 30a, 30b to allow a source of pressurised air to be connected to the ports 24a, 24b of the drive unit 20, which provides the power for operation of the drive unit 20. The bottom end 25a of the drive shaft 25 which protrudes from the bottom of the drive unit 20 through the lower casing 22, includes a flat face portion 31 on its side. A disc 32 is mounted to the bottom end 25a of the shaft 25 by the bottom end 25a of the shaft 25 extending through a central aperture 33 in the disc 32. The disc 32 is secured in place on the shaft 25 using a grub screw 34 which extends through a threaded aperture 35 in the side of the disc 32 and which is tightened against the flat face portion 31 of the drive shaft 25. The disc 32 includes two threaded holes 36 extending through the disc 32 parallel to the central aperture 33 and positioned diametrically opposite each other.

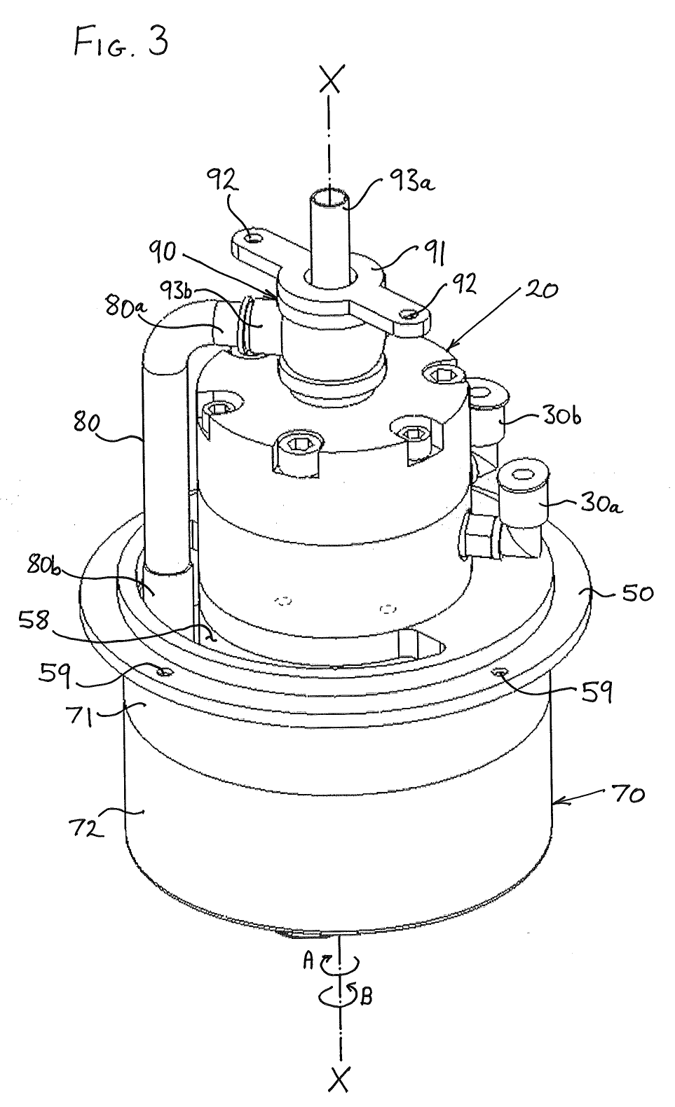

In use, the drive unit 20 causes the drive shaft 25 to move back and forth in a reciprocating rotating motion about its central axis X-X, as shown by arrows ‘A’ and ‘B’ in FIGS. 3, 6 and 11. This motion is provided by a supply of pressurised air being connected to the two connection pipes 30a, 30b to supply the pressurised air to the inner chamber 23 through the ports 24a, 24b. In use, pressurised air is alternately supplied to the first and second ports 24a, 24b of the drive unit 20 through the first and second connection pipes 30a, 30b. Initially, pressurised air is supplied to the first port 24a. The configuration of the inner chamber 23 of the drive unit 20 is such that the air pressure acts on one side of the piston 26 and forces it in the direction of arrow ‘A’ and thereby drives the drive shaft 25 clockwise until the piston 26 abuts the first stop 27a. At this point, the supply of pressurised air to the first port 24a is stopped and pressurised air is then supplied to the second port 24b. The configuration of inner chamber 23 of the drive unit 20 is such that the air pressure then acts on the opposite side of the piston 26 and forces it in the direction of arrow ‘B’ and thereby drives the drive shaft 25 anti-clockwise until the piston 26 abuts the second stop 27b. It will be appreciated that rotation of the drive shaft 25, also causes rotation of the disc 32 mounted to the drive shaft 25.

The above process of alternately supplying pressurised air to the first port 24a then the second port 24b is repeated and so the drive shaft 25 reciprocates back and forth in the direction of arrows A and B about its central axis X-X. This provides the driving motion for the massage device 10. The above operation is possible with a range of air pressures, but is preferably more than 1.5 kg/cm². When pressurised air is supplied to one of the ports 24a/24b, the other of the ports 24a/24b acts as an air outlet port. The alternating supply of pressurised air is provided by an air compressor, electric air valve and a control circuit (not shown). The rotation speed of the drive shaft 25 is controlled by the control circuit which controls the rate of alternating pressurised air supply. For example, this rotation frequency may be between 1-2.5 Hz, although many other rotation frequencies are possible within the scope of the invention.

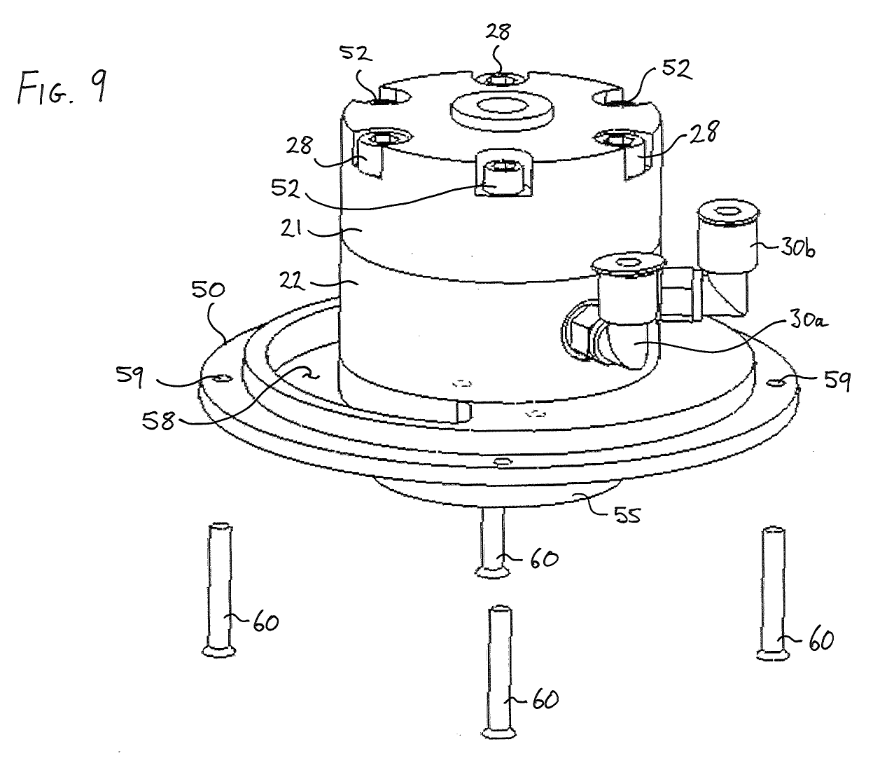

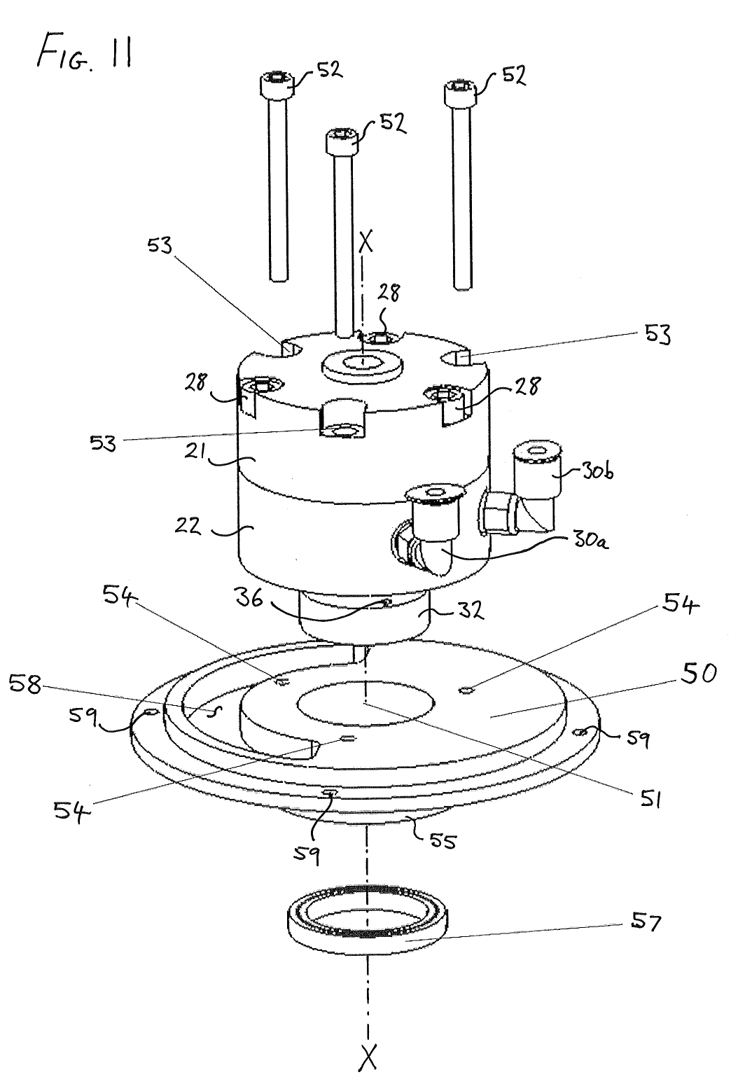

Referring now to FIGS. 9-12, the drive unit 20 is shown with the support plate 50 mounted to it. The support plate 50 comprises a circular disc with a central aperture 51 through which the bottom end 25a of the drive shaft 25 and associated disc 32 extend. The support plate 50 is secured to the drive unit 20 by three bolts 52 which extend from the top of the upper casing 21, through apertures 53 extending all the way through the side wall thereof and extending all the way though the side wall of the lower casing 22, and are received in correspondingly positioned threaded apertures 54 formed in the support plate 50 (see FIG. 11). It can be seen from FIGS. 9 and 11 that the bolts 52 which secure the support plate 50 to the drive unit 20 are spaced equidistantly around the top of the upper casing 21, and are spaced between the bolts 28 which secure the upper casing 21 to the lower casing 22.

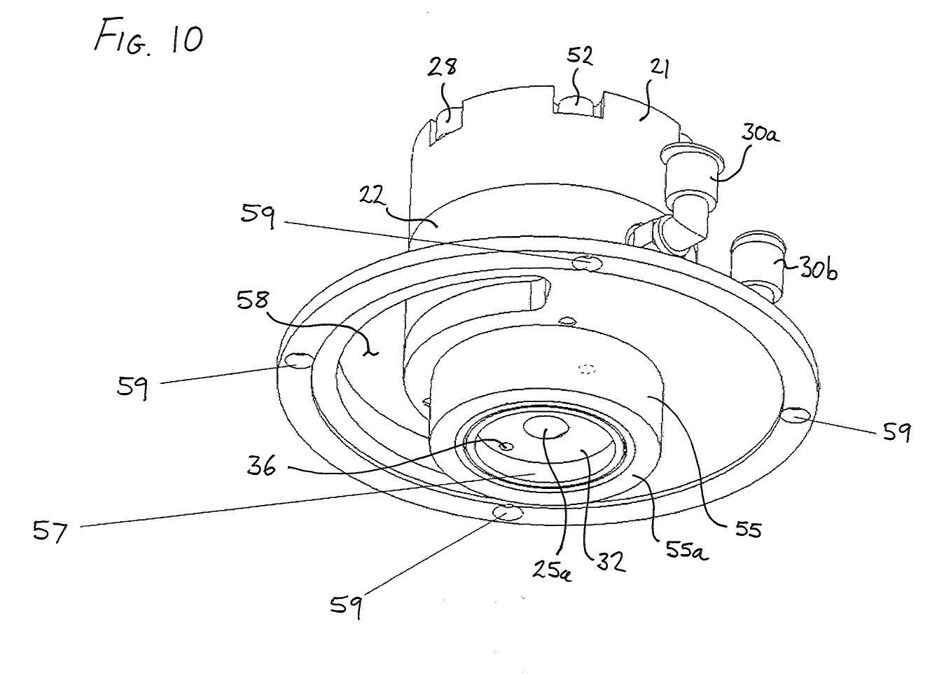

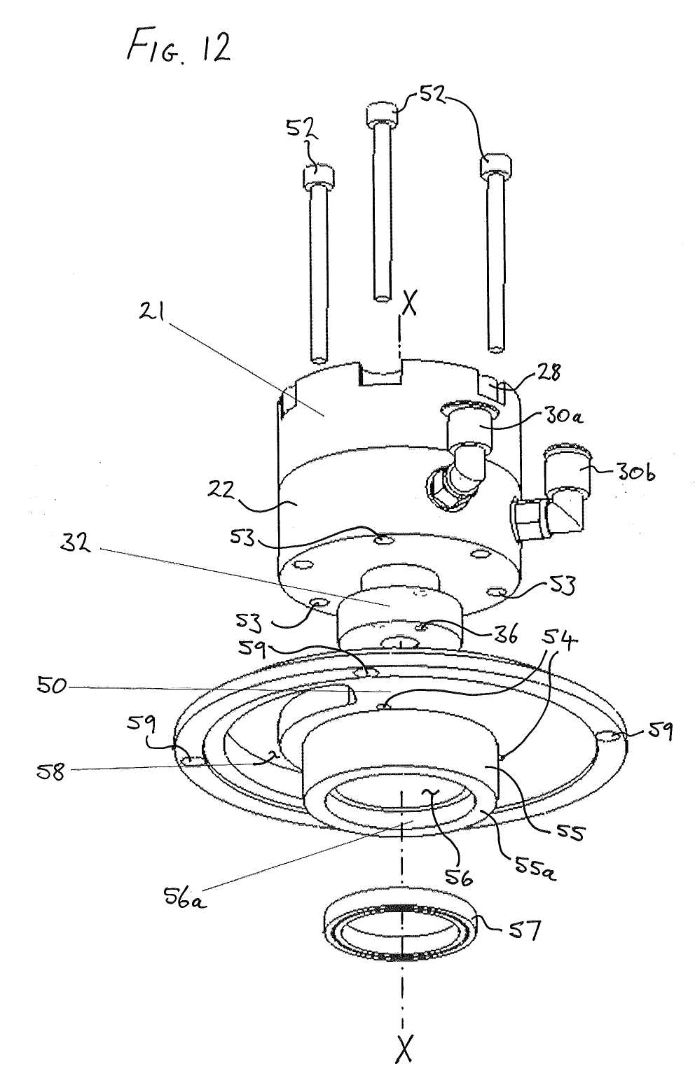

The underside of the support plate 50 includes a wall 55 depending perpendicularly around the perimeter of the central aperture 51 which defines a cavity 56 within the perimeter of the wall 55 (see FIG. 12). The disc 32 sits within the cavity 56 and is recessed inwards from the outer rim 55a of the wall 55, as can be seen in FIG. 10. An annular bearing 57 is disposed within the cavity 56 adjacent the disc 32 and proximate the outer rim 55a of the wall 55 from the disc 32. The outer diameter of the bearing 57 matches the inner diameter 56a (see FIG. 12) of the circular cavity 56 such that the bearing 57 can make a press-fit within the cavity 56.

An arcuate slot 58 is formed around a portion of the circumference of the support plate 50 and proximate the outer perimeter thereof. The outer perimeter of the support plate 50 includes four mounting holes 59. The support plate 50 is secured to the outer housing 12 by bolts 60 (see FIG. 9) which extend though the mounting holes 59 and are received in correspondingly positioned threaded apertures 61 (see FIG. 2) formed in the outer housing 12.

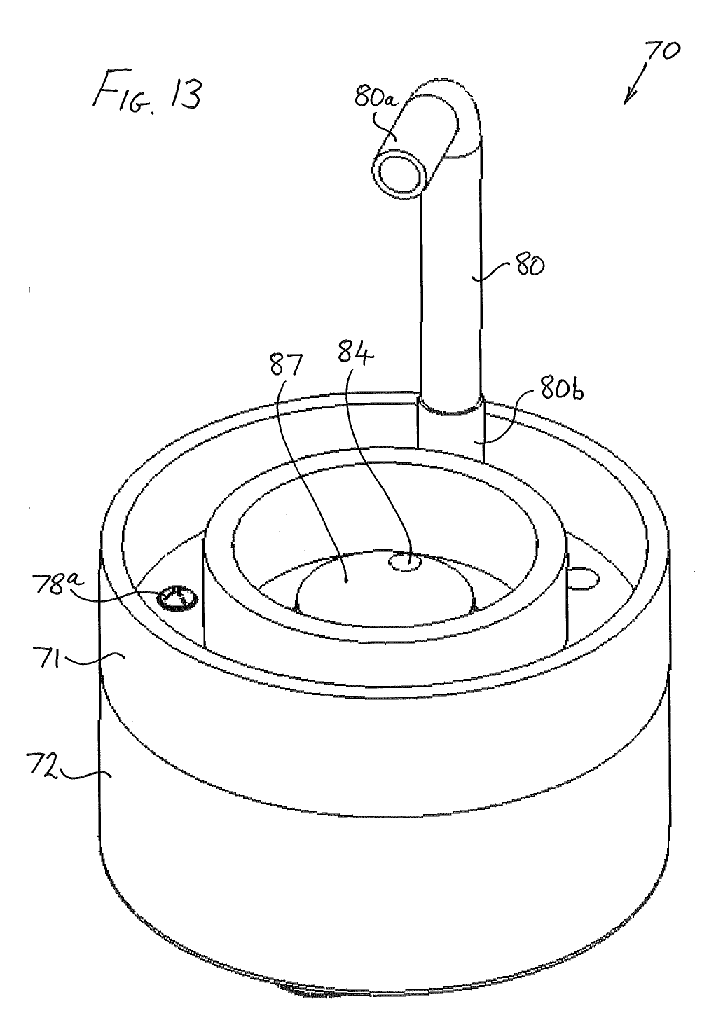

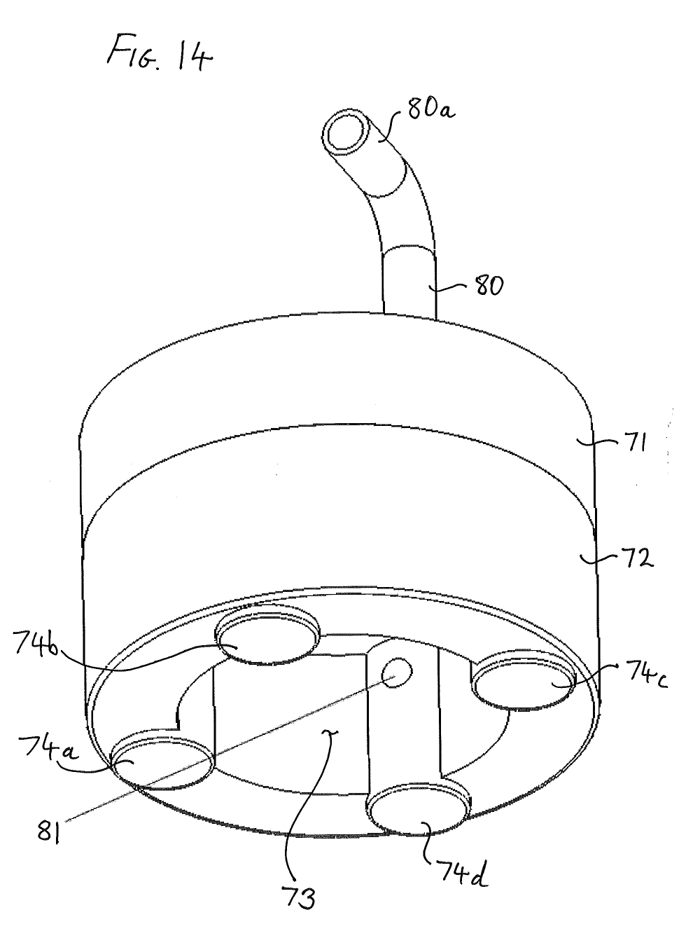

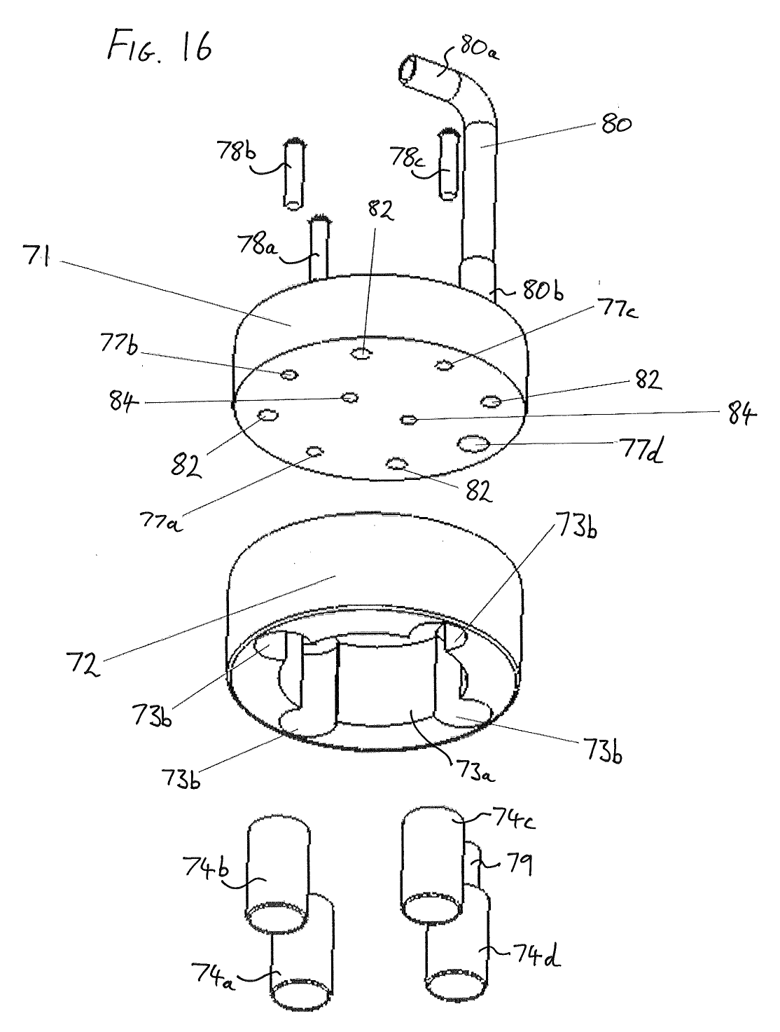

Referring now to FIGS. 13 to 16, the rotatable head 70 of the invention is shown and comprises an upper portion 71 and a lower portion 72. The upper portion 71 comprises a plastic disc and the lower portion 72 comprises a transparent plexi-glass cylinder with a central cavity 73 extending from the bottom of the lower portion 72 part-way therethough, i.e. the central cavity 73 does not extend all of the way through the lower portion 72. The central cavity 73 in the lower portion 72 is formed by a central circular aperture 73a with four smaller circular apertures 73b around the outside of, and intersecting, the central circular aperture 73a (see FIG. 16).

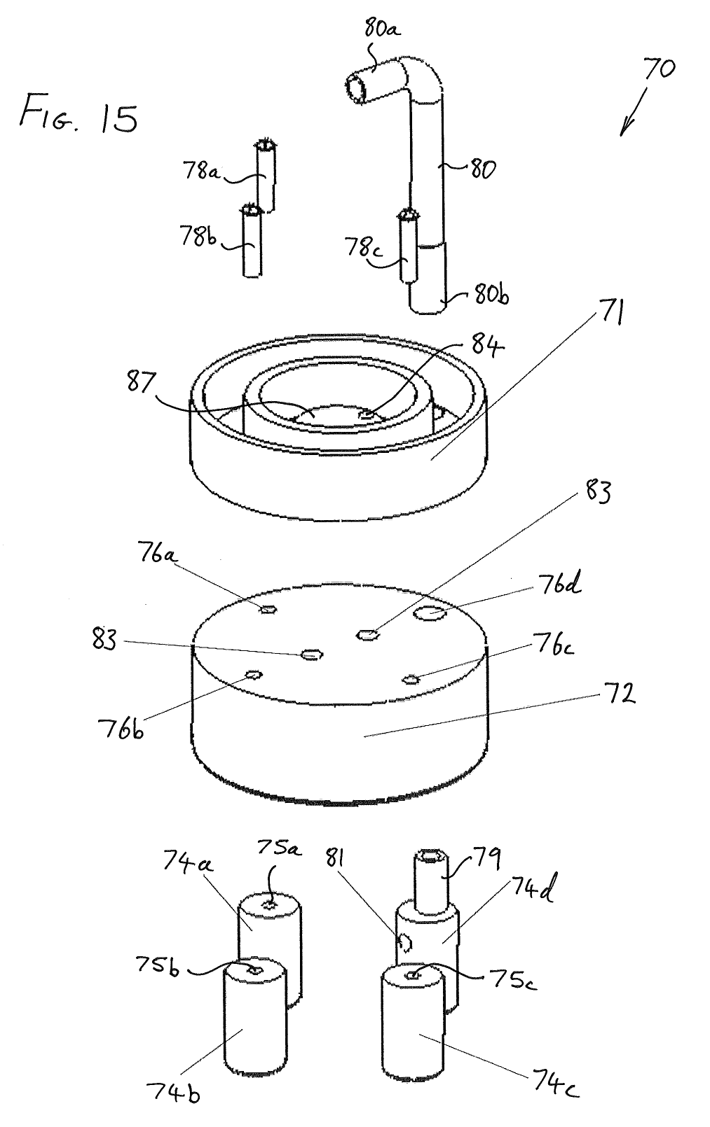

A metal post 74a, 74b, 74c, 74d is disposed in each of the smaller circular apertures 73b. Three of the metal posts 74a-74c include threaded apertures 75a-c extending into the post 74a-c from their top faces, and the lower portion 72 includes three holes 76a-c extending therethrough from the upper surface of the lower portion 72 to the respective smaller circular apertures 73b, one hole 76a-c located directly in line with each of the threaded apertures 75a-c. The upper portion 71 includes three corresponding holes 77a-c extending all the way therethrough and aligned with the three holes 76a-c in the lower portion 72 (see FIG. 16). The three posts 74a-c are fixed to the lower portion 72 by bolts 78a-c (see FIGS. 15 and 16) extending through the holes 77a-c in the upper portion 71, through the holes 76a-c in the lower portion 72, and being secured in the respective threaded aperture 75a-c in the posts 74a-c.

The fourth post 74d does not have a threaded aperture like the other three posts, but instead, includes a hollow threaded shaft 79 upstanding from its top face. The lower portion 72 includes a fourth hole 76d extending therethrough from the upper surface of the lower portion 72 to the fourth smaller circular aperture 73b in which the fourth post 74d fits, the fourth hole 76d being located directly in line with the threaded shaft 79 and being sized to allow the threaded shaft 79 to fit though the hole 76d. The upper portion 71 also includes a fourth hole 77d extending all the way therethrough and aligned with the fourth hole 76d in the lower portion 72. The fourth hole 77d in the upper portion 71 is also sized to allow the threaded shaft 79 of the fourth post 74d to fit therethough.

The rotatable head 70 includes an elongate vacuum pipe 80 which has an upper end 80a bent at 90 degrees to the rest of the pipe 80, and a lower end 80b which has an internal thread (not shown) corresponding to the thread on the threaded shaft 79 on the fourth post 74d. The fourth post 74d is fixed to the lower portion 72 by the threaded shaft 79 extending through the respective fourth holes 76d, 77d in the lower and upper portions 72, 71 and being secured in the threaded lower end 80b of the vacuum pipe 80.

The fourth post 74d is hollow such that a continuous hollow bore extends through the hollow threaded shaft 79 and through the fourth post 74d. The fourth post 74d also includes a suction hole 81 which is in fluid communication with the continuous hollow bore of the fourth post 74d and the hollow threaded shaft 79, and thus, it will be appreciated that air within the central cavity 73 can be extracted through the suction hole 81 in the fourth post 74d, though the hollow threaded shaft 79 and through the vacuum pipe 80.

In use, the bottom face of the lower portion 72 and the bottom ends of the posts 74a-d are in contact with the skin being massaged, and so these surfaces are polished to be very smooth. Furthermore, in use, a vacuum is generated in within the central cavity 73 by extracting air therefrom via the fourth post 74d and vacuum pipe 80, as will be described in more detail hereafter. Hence, the skin being massaged is drawn up into the central cavity 73 by the vacuum. The four posts 74a-d may further include an adhesive between themselves and the lower portion 72 to ensure that there is no path for air to escape around the posts 74a-d and through the holes 76a-d in the lower portion 72, such that when the rotatable head 70 is pressed against the skin to be massaged (and so the skin makes an airtight seal against the bottom edge of the rotatable head 70), the only fluid path to and from the central cavity 73 is via the fourth post 74d and the vacuum pipe 80, to enable a reduced pressure/vacuum to be maintained in the central recess 73.

The upper portion 71 may also include four additional holes 82 on its underside which are spaced around the perimeter of the upper portion 71 between the post-mounting holes 77a-d. These additional holes 82 may contain LEDs or laser generating means, such that light and/or heat generated thereby can pass through the transparent lower portion 72 to the skin of the person being massaged.

The four posts 74a-d are preferably metallic, and may be electrically connected to a source of radio frequency (RF) or low-impulse current (not shown) such that the RF/current can be conducted to the skin of the person being massaged.

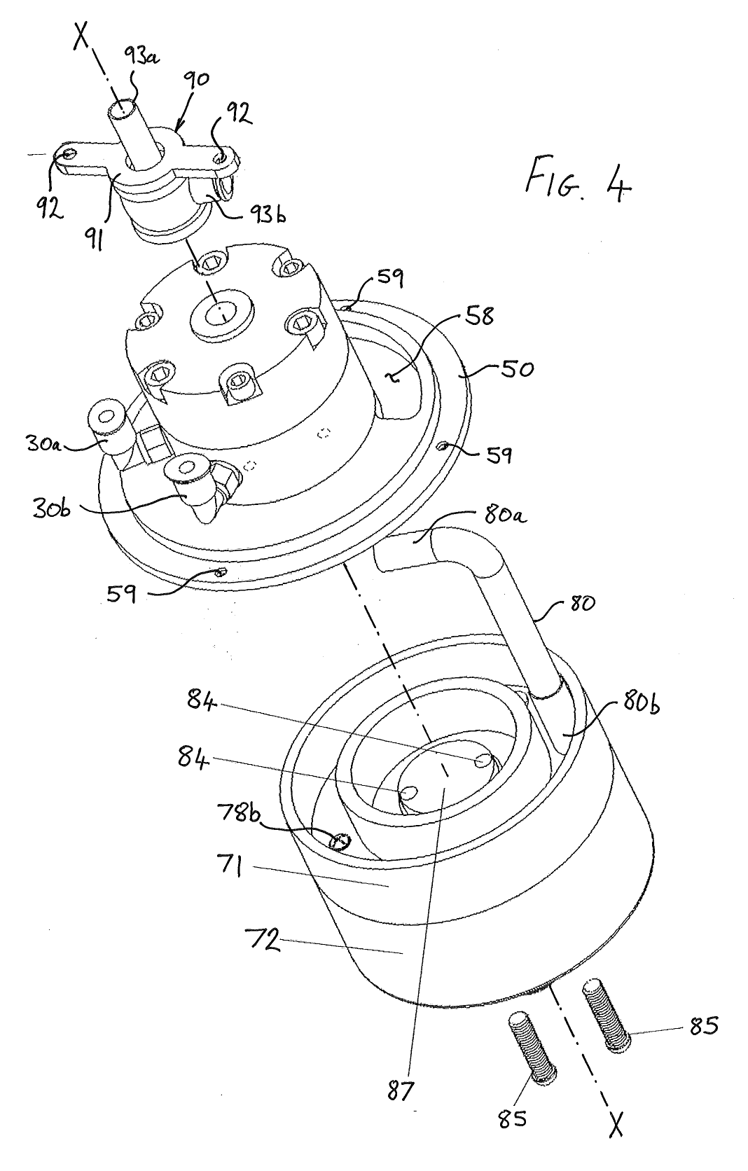

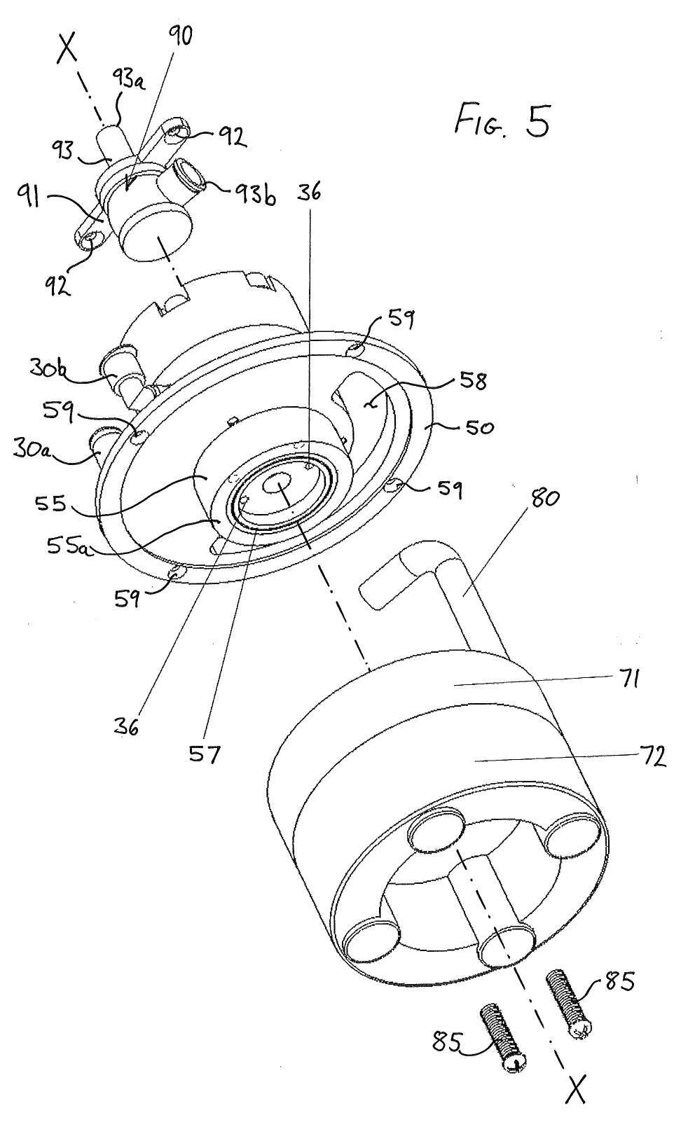

The lower portion 72 includes a pair of head-mounting holes 83 extending therethrough, and the upper portion 71 also includes a pair of head-mounting holes 84 extending therethrough and aligned with the head mounting holes 83 in the lower portion 72. The rotatable head 70 is secured to the drive unit 20 by two head-mounting bolts 85 which extend through the head-mounting holes 83, 84 in the lower and upper portions 72, 71 respectively, and are received in threaded apertures 36 in the disc 32 (see FIGS. 4 and 5).

Referring now to FIGS. 3 to 5, the drive unit 20 is shown with the support plate 50 and rotatable head 70 attached thereto. The upper surface of the upper portion 71 includes a circular projection 87 which has an external diameter to match the internal diameter of the bearing 57 so that the circular projection 87 fits in the bearing 57 when the rotatable head 70 is secured to the drive unit 20. Further, it can be seen that the vacuum pipe 80 extends through the slot 58 in the support plate 50. Thereby, when the rotatable head 70 is driven by the drive unit 20 as described above, to oscillate back and forth about the central axis X-X in the direction of arrows A and B, the vacuum pipe 80, which is fixed relative to the rotatable head 70, is free to move back and forth along the arcuate slot 58 and so does not hinder the rotation of the rotatable head 70.

It can be seen from FIGS. 2 to 5 that the massage device 10 includes a rotary air connector 90 comprising a support bar 91 having fixing holes 92 at each distal end of the bar 91, and an air duct 93 rotatably coupled to the support bar 91 though a hole in the centre thereof. The air duct 93 includes an upper end 93a directed straight upwards away from the drive unit 20 and rotatable head 70 and aligned with the central axis X-X of the drive unit 20/rotatable head 70, and lower end 93b which is angled at 90 degrees to the upper end 93a. The lower end 93b is sealingly coupled to the upper end 80a of the vacuum pipe 80. The upper end 93a of the air duct 93 is connectable to a vacuum source (not shown) such that, in use, air in the central cavity 73 can be evacuated via the fourth post 74d, the vacuum pipe 80 and the air duct 93.

The rotary air connector 90 is coupled to the outer housing 12 by bolts/screws (not shown) extending though the fixing holes 92 and into the outer housing (see FIG. 2). Thereby, the air duct 93 is rotatable together with the rotatable head 70 relative to the support bar 91, outer housing 12 and drive unit 20. The vacuum source is to be connected to the upper end 93a of the air duct 93 by a flexible hose or similar means, to allow the rotatable head 70 and air duct 93 to move relative to the outer housing 12 and drive unit 20, without the vacuum source becoming disconnected from the air duct 93.

The outer housing 12 includes a supply tube 16 extending therefrom distal to the rotatable head 70. The supply tube 16 provides a passage into the inside of the outer housing 12 and in use, pipes (not shown) supplying pressurised air to the first and second ports 24a, 24b and a pipe (not shown) connecting the air duct 93 of the rotary air connector 90 to a vacuum supply are provided through the supply tube 16. In addition, electrical connector wires (not shown) to power the LED/laser generating means in the upper portion 71 of the rotatable head 70, and to supply RF/low impulse current to the four metal posts 74a-d are provided through the supply tube 16.

Operation of the massage device 10 will now be described. An operator holds the massage device 10 by the two handles 14 and places the bottom edge of the rotatable head 70 on the skin of a person being massaged. Thus, the highly polished lower face of the lower portion 72 of the rotatable head 70 and the highly polished bottom faces of the four metal posts 74a-d are in contact against the skin and thereby seal the central cavity 73 from the ambient atmosphere.

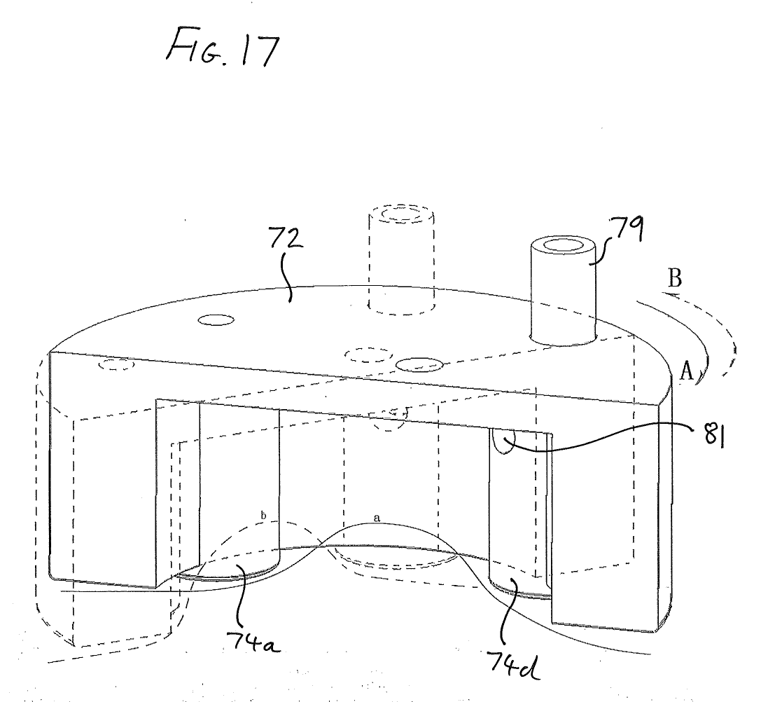

The operator then switches the massage device 10 on, which causes the vacuum supply to draw air out of the central cavity 73 via the suction hole 81, hollow bore and hollow threaded shaft 79 of the fourth post 74d, through the vacuum pipe 80 and though the air duct 93 of the rotary air connector 90. The resulting vacuum in the central cavity 73 sucks the skin up into the central cavity 73, and thereby against the inside wall of the central cavity 73 between the posts 74a-d, and against the posts 74a-d themselves which extend inwardly relative to the inside wall of the central cavity 73. This is shown schematically in the solid line ‘a’ in FIG. 17.

At the same time, the supply of pressurised air is provided alternately to the first and second ports 24a, 24b via the connection pipes 30a, 30b respectively, controlled by the control circuit, electric valve and air compressor (not shown). As described above, the alternating pressurised air supply causes the drive shaft 25 of the drive unit 20 to oscillate back and forth in a rotation motion about its central axis X-X in the direction of arrows A and B. Thereby, the rotatable head 70 is driven to oscillate back and forth as it is secured to the disc 32 mounted to the drive shaft 25.

As the rotatable head 70 oscillates back and forth, the folds of skin ‘a’ that are sucked up into the central cavity 73 against the inside wall thereof between the posts 74a-d, are caused to be moved back and forth since the posts 74a-d, which extend further inwardly than the inside wall of the central cavity 73, push the folds of skin back and forth as the rotatable head 70 oscillates. For example, as the rotatable head 70 moves in the direction of dotted arrow B in FIG. 17, from the position shown in solid lines to the position shown in dashed lines, the fold of skin shown in FIG. 17 moves from position ‘a’ to position ‘b’ shown in dashed lines. This repeated movement of the folds of skin sucked up into the central cavity 73 of the rotatable head 70 being pushed back and forth by the posts 74a-d, creates the effective massaging movement of the massage device 10.

In addition to the massaging operation described above, the massaging device can further enhance the massaging effect by activation of the LED or laser means in the upper portion 71 of the rotatable head 70. These transmit light through the side wall of the transparent lower portion 72 to directly heat the skin. Furthermore, RF or low-impulse current can be applied to the four metal posts 74a-d to be transmitted directly to the skin, to yet further enhance the massaging effect of the massage device 10.

The operation of the massage device 10, including the operation of the vacuum supply, the actuation of the rotatable head with the pressurised air supply and its associated control circuit and the LED/laser means and RF/low impulse current, may all be controlled by various actuators such as switches, buttons, dials, etc (e.g. see feature 18 in FIG. 2) mounted to the handles 14 of the outer housing. Thereby, all operations of the massage device 10 can be actuated by the operator with both hands still holding the handles 14. The various controls provided on the handles 14 may also be operable to alter the oscillation speed and frequency of the rotatable head 70 and the suction force applied to the rotatable head 70 by the vacuum supply.

Although the above embodiment is shown and described as having a drive unit 20 powered by pressurised air, it should be appreciated that the invention is not limited to such a drive unit, and alternative drive means may be included within the scope of the invention to actuate the rotatable head 70. For example, such alternative drive means may comprise an electric motor. The variation in oscillation speed of the rotatable head 70 may be controlled by appropriate speed control of the electric motor.

The support plate 50 as described in the above embodiment may be made of any suitable material, and can be, for example, made from plastic or metal.

Although the lower portion 72 of the rotatable head 70 in the above-described embodiment is made of a plexi-glass material, other suitable transparent materials may be used, such as Perspex or glass, which would allow the LED/laser light to pass through the lower portion to the skin. Furthermore, the invention is not limited to embodiments having LED/laser means, and in such an embodiment of the invention which does not include LED/laser means, the lower portion may be made of one or more of a number of other non-transparent materials.

Although the central circular aperture 73a of the central cavity 73 in the rotatable head 70 is shown and described as being substantially circular, with the posts 74a-d projecting into the central circular cavity 73a to form the undulating inside wall of the central cavity 73, it will be appreciated that the invention is not limited to such a shaped central cavity 73, and many other configurations are envisaged within the scope of the invention, either with or without the above described posts 74a-d projecting into such recess.

It is intended that the rotatable head for a massage device, and massage device incorporating such a rotatable head, may comprise any combination of two or more non-mutually exclusive features described in the above exemplary embodiment.

1. A massage device comprising
a drive unit and a rotatable head coupled to the drive unit for rotation about an axis, the rotatable head having a skin-engaging end face to contact skin to be massaged and a cavity in the skin-engaging end face extending into the rotatable head which is sealed closed when the rotatable head is pressed against the skin to be massaged and which is connectable to a source of vacuum to allow air to be evacuated from the cavity, wherein the skin-engaging end face lies in a plane substantially perpendicular to the axis of rotation of the rotatable head, characterized in that the rotatable head is rotatable about its central axis and the inner walls of the cavity comprise an undulating surface such that, in use, skin drawn into the cavity is pushed by the undulations, as the rotatable head rotates.

2. A massage device according to claim 1, wherein the drive unit is configured to oscillate the rotatable head back and forth about its axis of rotation.

3. (canceled)

4. A massage device according to claim 1, wherein the rotatable head includes a second end face opposite to the skin-engaging end face and, the rotatable head is coupled to the drive unit at the second end face.

5. (canceled)

6. A massage device according to claim 1, wherein the rotatable head includes a fluid passage extending therethrough and in communication with the cavity to allow air to be evacuated from the cavity when closed by skin being massaged.

7. A massage device according to claim 6, wherein the fluid passage includes a suction pipe mounted to the rotatable head in fluid communication with the cavity, for connection to a vacuum source to evacuate air from the cavity.

8. (canceled)

9. A massage device according to claim 1, wherein the cavity in the rotatable head is substantially circular with at least one element projecting from the inside circular wall of the cavity providing said undulating surface.

10. A massage device according to claim 9, wherein the at least one element comprises a post received in an aperture in the rotatable head.

11. A massage device according to claim 10, wherein the at least one post is metallic and is connected to a source of Radio Frequency or low impulse current to enable the same to be transmitted to the skin being massaged.

12. A massage device according to claim 10, wherein the fluid passage extends though the at least one post and the at least one post includes a suction hole open to the cavity and in fluid communication with the fluid passage.

13. A massage device according to claim 1, wherein the drive unit is pneumatically powered.

14. A massage device according to claim 1, configured such that the rotational speed of the rotatable head can be controlled within a range of different speeds.

15. (canceled)

16. A massage device according to claim 1, further comprising at least one LED or laser-emitting means operable to transmit light and/or heat to the skin being massaged.

17. A massage device according to claim 16, wherein the rotatable head comprises a transparent portion between the at least one LED/laser emitting means and the skin-engaging end face to allow light to be transmitted from the at least one LED/laser emitting means to the skin to be massaged.

18. A massage device according to claim 17, wherein the transparent portion is made of Plexiglas.

19. A massage device according to claim 1 further comprising, an outer housing enclosing the drive unit.

20. A massage device according to claim 19, wherein the outer housing includes at least one handle to facilitate manipulation of the massage device.

21. A massage device according to claim 20 further comprising, at least one actuator to control operation of the massage device.

22. A massage device according to claim 21, wherein the at least one actuator is mounted on the at least one handle.

23. A massage device according to claim 13 further comprising, a source of compressed air/gas to power the drive unit.

24. A massage device according to claim 23 further comprising, a control circuit to control operation of the massage device and drive unit thereof.

25. A massage device according to claim 24 further comprising, an electric valve controlled by the control circuit to regulate the supply of compressed air/gas to the drive unit.

26. A massage device according to claim 1, wherein the drive unit is electrically powered, and/or driven by an electric motor.

27. A massage device according to claim 6 further comprising, a suction device connected to the fluid passage to evacuate air from the cavity in the rotatable head.

28. A massage device according to claim 1, wherein the rotatable head is substantially cylindrical.

29. A method of massaging a persons skin using a massage device which comprises,
a drive unit and a rotatable head rotatable about a central axis of the head and having a skin-engaging end face to contact the skin to be massaged and a cavity in the skin-engaging end face extending into the rotatable head which lies in a plane substantially perpendicular to the axis of rotation of the rotatable head, the inner walls of the cavity having an undulating surface, the method comprising placing the skin-engaging end face on the skin to be massaged to seal closed the cavity, and
applying a suction force to the cavity to evacuate air therefrom and draw the skin into the cavity, actuating the drive unit to rotate the rotatable head about its central axis which is substantially perpendicular to the surface of the skin being massaged, and the skin drawn into the cavity being pushed by the undulations of the inner walls of the cavity.
